(19) United States
(12) Patent Application Publication
(10) Pub. No.: US 2005/0252010 A1
(43) Pub. Date: Nov. 17, 2005

(54) Exchangeable blade knife

(75) Inventor: Jeffrey M. Freeman, Salem, OR (US)

Correspondence Address: FOLEY & LARDNER, 777 EAST WISCONSIN AVENUE, SUITE 3800, MILWAUKEE, WI, 53202-5308, US

(73) Assignee: Fiskars Brands, Inc.

(21) Appl. No.: 10/847,239

(22) Filed: May 17, 2004

(51) Int. Cl. B26B 3/06

(52) U.S. Cl. 30/336; 30/335

(57) ABSTRACT

An exchangeable blade knife includes a handle and a blade adapted to be removably coupled to the handle. A bias mechanism is coupled to the handle, the bias mechanism applying a bias on the blade in a lateral direction to press the blade against the handle. The blade may be removed from the handle without also removing the bias mechanism from the handle.

### FIELD OF THE INVENTION

The present invention relates to a handheld knife having an exchangeable blade. In particular, the present invention relates to an exchangeable blade knife having an improved system for coupling the blade to the handle.

### BACKGROUND OF THE INVENTION

Fixed blade knives have a sharpened blade that is attached to a handle in any one of a variety of ways known in the art. In order to provide a secure feel and strong design, the blade typically has a tang portion that extends well into the handle, in many designs extending the length of the handle through to the back of the knife. The handle sides are secured to the tang of the blade with screws or other fasteners or with an adhesive. Because the blade and tang are typically made of metal, such as with steel, a one-piece blade and tang extending the length of the overall knife provides a strong design, as compared to designs having a shorter tang that is secured near the front end of the handle.

Certain knife designs provide the feature of a removable blade. A removable blade may be desirable in order to provide a knife system having a single handle that may be used with various types of blades, such as knife blades, saw blades, and other tools having a common attachment mechanism that may be secured to the handle. In such an exchangeable blade design, a mechanism used to secure the interchangeable blades with the handle is provided, such as a screw, lever, or button-type mechanism.

One challenge associated with exchangeable blade knife designs relates to securely coupling the blade to the handle. Because such designs are intended to provide the functionality of a fixed blade knife while providing the additional feature of an exchangeable blade, it is desirable to provide the secure feel of a conventional fixed blade knife having a tang that extends the length of the handle while also providing the exchangeability function. Accordingly, the design of the exchangeable blade knife must minimize movement or play in the blade when the blade is attached to the handle. Such play is typically manifested in uninhibited lateral movement of the blade that is permitted by free space between the blade tang and the handle sides when the components are assembled. Such free space is typically the result of manufacturing tolerances resulting in variability in the thickness of the blade tang and the thickness of the receiving slot in the handle.

One way of reducing play in the blade is to use a screw or screws to attach the exchangeable blade to the handle. Tightening the screw or screws reduces blade movement within the handle. However, a disadvantage of this approach is that the utilization of screws hampers the ease of exchanging the blade by requiring the user to manually remove and re-attach the screw or screws, and may require the use of an additional tool such as a screwdriver. Further, the use of a screw presents the disadvantage of having a loose part, such as the screw or a portion of the handle side, when exchanging the blade, which can increase the chances of dropping and perhaps losing a necessary part of the knife when exchanging blades.

Another approach to reducing movement of the blade in the handle is to tighten the manufacturing tolerances of the blade and/or the handle. For example, tightening the tolerance of the components will result in a decrease in the amount of play between the blade and the handle when the knife is assembled. A disadvantage of this approach is that tightening tolerances results in an increase in manufacturing costs, both in tooling and in the number of parts that must be reworked or discarded because the manufactured parts do not meet the prescribed tolerances.

Accordingly, there is a need for an exchangeable blade knife that is designed to reduce the amount of play between the blade and the handle when the knife is assembled while still affording an easy method of removing and attaching the exchangeable blades and without requiring attachment parts that must be removed from the handle when exchanging the blade. Further, there is a need for an exchangeable blade knife that exhibits reduced movement or play in the blade without also requiring higher manufacturing tolerances in the blade or handle components.

It would be desirable to provide a system and/or method that provides one or more of these or other advantageous features. Other features and advantages will be made apparent from the present specification. The teachings disclosed extend to those embodiments that fall within the scope of the appended claims, regardless of whether they accomplish one or more of the aforementioned needs.

### SUMMARY OF THE INVENTION

The invention relates to a knife having a handle and a blade adapted to be removably coupled to the handle. A bias mechanism is coupled to the handle, the bias mechanism applying a bias on the blade in a lateral direction to press the blade against the handle. The blade may be removed from the handle without also removing the bias mechanism from the handle.

The invention further relates to an exchangeable blade knife system having a handle and a blade. The blade has a working position in which the blade is secured to the handle and a removed position in which the blade is not secured to the handle. A bias mechanism is coupled to the handle, the bias mechanism applying a bias on the blade in a lateral direction to press the blade against the handle when the blade is in the working position. The bias mechanism remains coupled to the handle when the blade is moved from the working position to the removed position.

The invention further relates to a knife having a handle and a blade adapted to be removably coupled to the handle. A means for biasing the blade against the handle applies a bias on the blade in a lateral direction to press the blade against the handle. The blade may be removed from the handle without removing the means for biasing the blade against the handle from the handle.

The invention is capable of other embodiments and of being practiced or being carried out in various ways. Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a perspective view of an exchangeable blade knife;

FIG. 2 is an exploded perspective view of an exchangeable blade knife;

FIG. 3 is a cut-away elevation view of an exchangeable blade knife;

FIG. 4 is a cut-away elevation view of an exchangeable blade knife with the exchangeable blade removed from the handle;

FIG. 5 is a sectional view taken generally along line 5-5 of FIG. 3;

FIG. 6 is a sectional view taken generally along line 6-6 of FIG. 4;

FIG. 7 is a sectional view taken generally along line 7-7 of FIG. 3; and

FIG. 8 is a sectional view taken generally along line 8-8 of FIG. 4.

### DESCRIPTION OF PREFERRED EMBODIMENTS

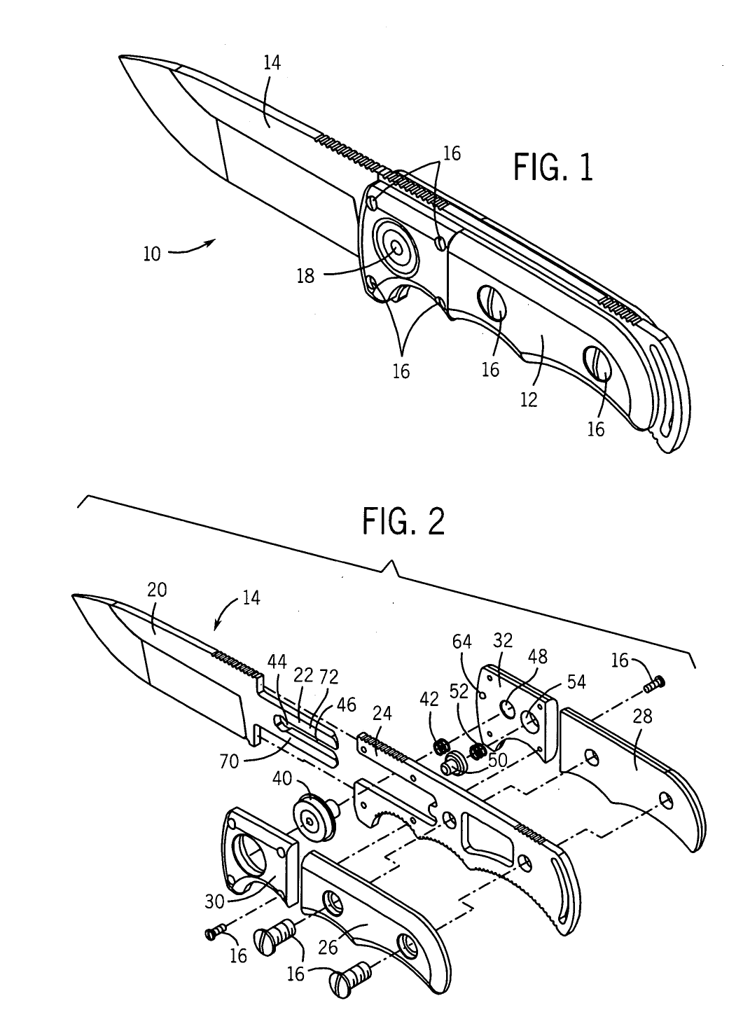

Referring to FIG. 1, according to an exemplary embodiment of the present invention, a knife, shown as exchangeable blade knife 10, has a handle 12 and a blade 14. The handle may include various elements or pieces secured together by fasteners 16. In the embodiment depicted in FIG. 1, knife 10 is an exchangeable blade knife having a removable blade 14 that is removed by depressing release mechanism 18. In a typical knife construction, blade 14 is made of metal, such as steel or aluminum, and the handle components may be made of a variety of materials including wood, plastic, metal, or various composites. The term “blade” is not intended to be limiting and may include various types of blades and tools, such as knife blades, saws, skinners, and so forth as is known in the art. Further, the term “handle” is intended to be a generic term referring to all of the components in the handle portion of the knife including various liners, handle sides, bolsters, frames, receivers, and so forth as is known in the art.

Referring to FIG. 2, blade 14 includes a working portion 20 and a tang 22. The working portion 20 may be sharpened to function as a cutting instrument and may be made in various shapes and sizes. In an exemplary embodiment, the handle 12 includes a receiver 24, a pair of handle halves 26, 28, and a pair of bolsters, mark bolster 30 and pile bolster 32. The receiver 24 may be made of a material similar to the blade 14, such as steel. The other handle components may be made of other materials as is desired for comfort, durability, and decorative purposes.

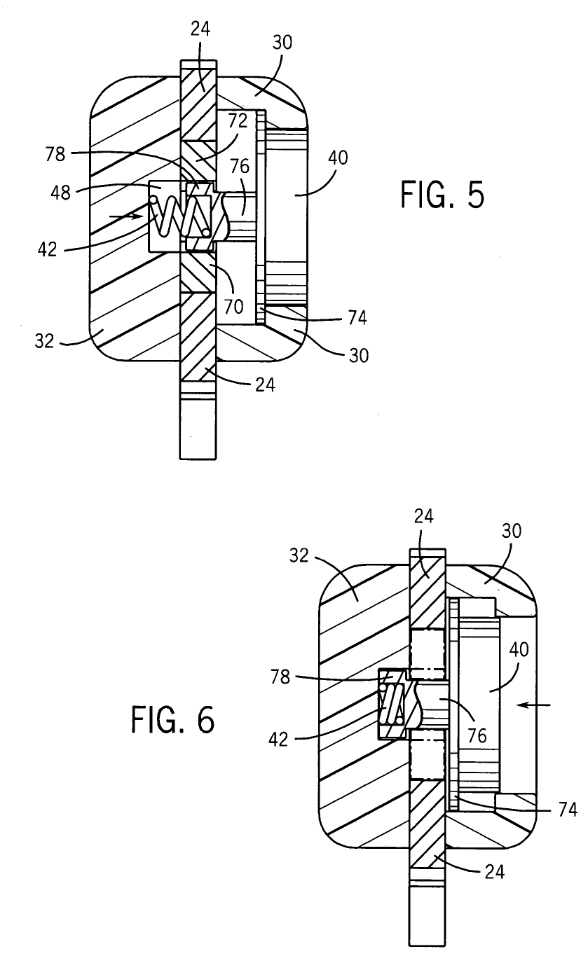

Further referring to FIG. 2, a release button 40 and a compression spring, shown as release button spring 42, are used in conjunction with one another to both retain the blade 14 in the handle and to release the blade 14 from the handle. When assembled, a portion of the release button 40 extends through aperture 44 in tang 22 to lock the blade 14 into place. To release the blade 14, the release button 40 may be depressed against the force of release button spring 42 to disengage the end portion of the release button 40 from the aperture 44, allowing a narrower portion of release button 40 to slide through a slot 46 in the tang 22 as the blade 14 is released from the handle 12. The components of the release mechanism are described in more detail below with respect to FIGS. 5 and 6. The release button spring 42 normally biases the release button 40 into the locked position. In the exemplary embodiment shown in FIG. 2, one end of spring 42 normally resides in a recess 48 in the pile bolster 32.

Further referring to FIG. 2, a blade bias mechanism, shown as, but not limited to, pin 50 and corresponding pin spring 52, is used to apply pressure to the tang 22 when blade 14 is assembled with handle 12. The pressure or bias on tang 22 reduces the movement or play of blade 14 within handle 12. Because the pin 50 has a head portion that is wider than slot 46, and an end portion that is narrower than slot 46, the pin 50 is configured to permit the blade 14 to be inserted and removed from receiver 24 while still providing a bias against the tang 22 when assembled. In the embodiment depicted in FIG. 2, the pin spring 52 partly resides in a recess 54 in the pile bolster 32.

Further referring to FIG. 2, the leading edge of the tang 22 may be beveled such that as blade 14 is inserted into receiver 24, the tang 22 automatically moves release button 40 and pin 50 to allow passage of the tang 22 past the release button 40 and pin 50.

Further referring to FIG. 2, a blade bias mechanism, shown as recessed ball and spring mechanism 64, is located in the pile bolster 32 in an exemplary embodiment. The spring-biased ball provides an additional bias on tang 22 when the blade 14 is assembled with handle 12 to reduce the play of blade 14. A ball and spring mechanism (not shown) may be provided in the mark bolster 30 instead of, or in addition to, the ball and spring mechanism 64 as to provide a lateral bias on both sides of the tang 22, and further reduce the potential for movement of blade 14 within handle 12.

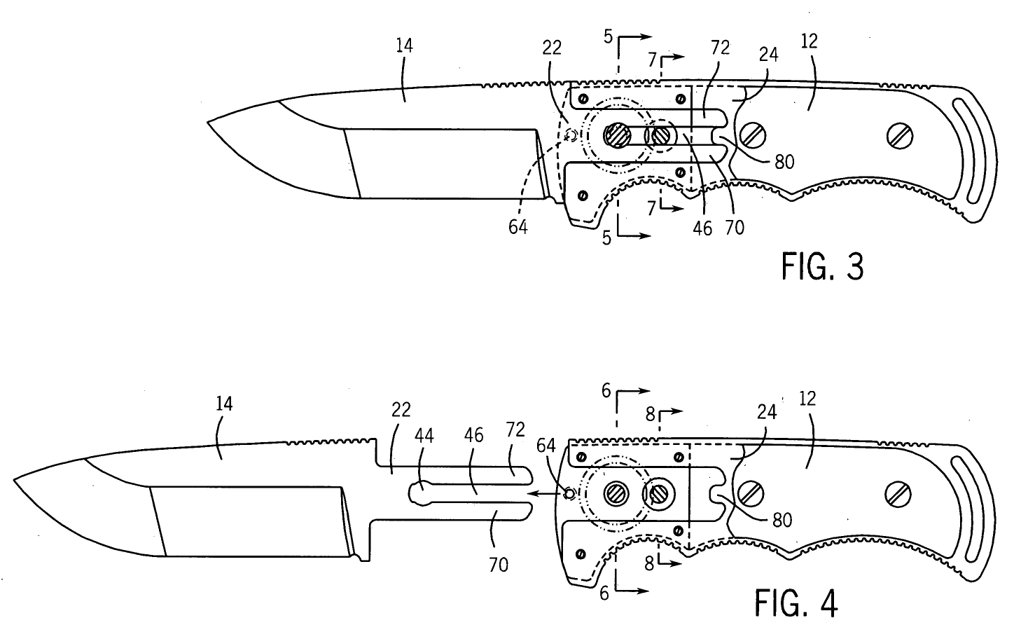

Referring to FIGS. 2, 3, and 5, tang 22 has a pair of prongs 70, 72 that define slot 46 and aperture 44. The release button 40 has a shaft 76 and an end portion 78, the end portion 78 having a larger diameter than shaft 76. The shaft 76 has a diameter that is more narrow than the width of slot 46 between prongs 70, 72. The diameter of end portion 78 is less than the diameter of aperture 44, but greater than the width of slot 46. Accordingly, when end portion 78 resides within aperture 44, the blade 14 is locked in place because the end portion 78 prevents sliding of the blade 14 in the outward direction due to interference with the slot 46. A flange 74 prevents the release button spring 42 from pushing the release button 40 any further outward from the handle 12 than is shown in FIG. 5 due to interference with the mark bolster 30. Referring specifically to FIG. 3, receiver 24 includes a tongue 80 that is sized to extend partially into slot 46 to aid in fixing the tang 22 into place within handle 12. The end portion 78 of the release button 40, in combination with the receiver tongue 80, secure, the blade 14 into place and prevent movement of the secured blade 14 in the longitudinal direction and the vertical direction of the blade 14. However, play may still exist in the lateral direction due to variations in the blade 14 and receiver 24 thicknesses, requiring the blade bias mechanisms described herein to remove the play by applying a bias on the blade 14 in a lateral direction.

In another exemplary embodiment (not shown), the end portion 78 and the aperture 44 may be configured to mechanically interfere with one another to function as a blade bias mechanism in addition to a release and locking mechanism. For example, the end portion 78 may be tapered such that the distal end of the end portion is wider than the diameter of the aperture so that the end portion 78 wedges into the aperture 44 when the blade 14 and handle 12 are assembled. Because of the interlocking of the end portion 78 and the aperture 44, the release button spring 42 provides a bias on the tang 22 in a lateral direction against the handle 12 when the blade 14 and handle 12 are assembled in such an embodiment.

Referring to FIGS. 4 and 6, release button 40 is depressed in a lateral direction (see arrow in FIG. 6) to release the blade 14 from handle 12. When release button 40 is sufficiently depressed, end portion 78 is displaced out of aperture 44 and replaced by shaft 76, which has a diameter that is more narrow than the slot 46. Accordingly, the user is able to withdraw blade 14 from handle 12 in order to remove and exchange the blade 14.

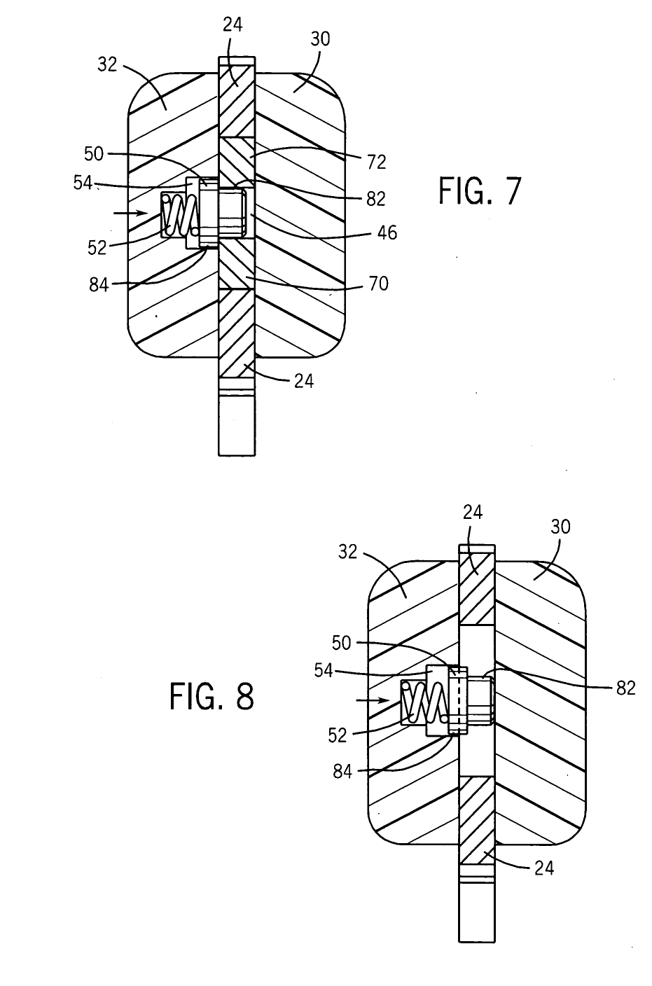

Referring to FIGS. 3 and 7, in an exemplary embodiment, the blade bias mechanism, shown as pin 50, and pin spring 52, has a shaft 82 that is more narrow than the width of slot 46 and a pin flange 84 that is of a greater diameter than the width of the slot 46. Accordingly, when the blade 14 is assembled with the handle 12, pin flange 84 applies pressure in a lateral direction (see arrow in FIG. 7) against prongs 70, 72 to reduce play in the blade 14.

Referring to FIGS. 4 and 8, when the blade 14 has been removed from the handle 12, a portion of the pin flange 84 is forced into the plane of the receiver 24, into a position that would ordinarily interfere with the insertion of tang 22 into handle 12. However, as discussed above, the prongs 70, 72 are beveled to cause the pin flange 84 to be moved aside as blade 14 is inserted into handle 12.

In operation, the blade 14 may be released from the handle 12 in order to exchange the blade 14 with another blade or tool by depressing the release button 40 and pulling the blade 14 out of handle 12. Accordingly, the required mechanical actions necessary to disassemble blade 14 and handle 12 are simplified relative to devices that require the removal of fasteners or the activation of multiple components such as levers and so forth to release the exchangeable blade. Further, the removal operation does not result in loose parts, such as screws, that present the risk of being lost when a blade is being removed and replaced.

In order to address the issue of excessive movement or play in the blade 14 when assembled with the handle 12, especially without the utilization of extra fasteners, the blade bias mechanism removes play by applying force in a lateral direction on the tang 22. The blade bias mechanism may be in the form of the ball and spring mechanism 64 or the pin 50 and spring 52 in two of the embodiments described herein, but may also take other mechanical forms involving mechanisms that apply force on the blade 14 in a lateral direction in order to remove play on the blade 14 when the knife 10 is assembled. Without the utilization of the blade bias mechanism (one such mechanism or multiple mechanisms in combination with one another) the tolerances on the thickness of the blade and handle components would have to be tightened to reduce the amount of play, with a corresponding increase in manufacturing costs and defects. The addition of the blade bias mechanism allows for an increased tolerance, such as permitting a 0.020 inch mismatch in blade-to-handle thickness, both decreasing the cost to manufacture and increasing the quality of the knife relative to alternative approaches of tightening the tolerances on the thickness of all components to within ±0.001-0.002 inches.

While the detailed drawings and specific examples given herein describe various-exemplary embodiments, they serve the purpose of illustration only. It is to be understood that the invention is not limited in its application to the details of construction and the arrangements of components set forth in the preceding description or illustrated in the drawings. For example, the particular release mechanism and tang configuration is but one way of attaching an exchangeable blade to a handle. Further, the blade bias mechanism is shown in one embodiment as having a shaft and flange configuration to apply a spring bias to the tang but may take other forms that permit the application of a bias to the blade to reduce play in the blade Furthermore, other substitutions, modifications, changes, and omissions may be made in the design, operating conditions, and arrangements of the exemplary embodiments without departing from the scope of the invention as expressed in the appended claims.

1. A knife, comprising:
a handle;
a blade adapted to be removably coupled to the handle; and
a bias mechanism coupled to the handle, the bias mechanism applying a bias on the blade in a lateral direction to press the blade against the handle;
wherein the blade may be removed from the handle without also removing the bias mechanism from the handle.

2. The knife of claim 1, wherein the bias mechanism comprises a compression spring.

3. The knife of claim 1, wherein the handle comprises a receiver and a pair of handle halves coupled to opposite sides of the receiver.

4. The knife of claim 3, wherein the bias mechanism is disposed in a recess in one of the handle halves.

5. The knife of claim 4, wherein the bias mechanism comprises a ball and a spring disposed between the ball and the one of the handle halves.

6. The knife of claim 1, wherein the bias mechanism comprises a pin having a flange and a compression spring coupled between the pin and the handle, the flange pressing against a tang of the blade.

7. The knife of claim 1, wherein the blade comprises a working portion and a tang having a pair of prongs and wherein the bias mechanism presses against the pair of prongs.

8. The knife of claim 1, further comprising a second bias mechanism coupled to the handle, the second bias mechanism applying a bias on the blade in the lateral direction to press the blade against the handle.

9. The knife of claim 8, further comprising a third bias mechanism coupled to the handle, the third bias mechanism applying a bias on the blade in the lateral direction to press the blade against the handle.

10. The knife of claim 1, further comprising a release button configured to couple the blade to the handle and wherein the release button applies a bias on the blade in the lateral direction to press the blade against the handle.

11. An exchangeable blade knife system, comprising:
a handle;
a blade having a working position wherein the blade is secured to the handle and a removed position wherein the blade is not secured to the handle; and
a bias mechanism coupled to the handle, the bias mechanism applying a bias on the blade in a lateral direction to press the blade against the handle when the blade is in the working position;
wherein the bias mechanism remains coupled to the handle when the blade is moved from the working position to the removed position.

12. The exchangeable blade knife system of claim 11, wherein the bias mechanism comprises a compression spring.

13. The exchangeable blade knife system of claim 11, wherein the handle comprises a receiver and a pair of handle halves coupled to opposite sides of the receiver.

14. The exchangeable blade knife system of claim 13, wherein the bias mechanism is disposed in a recess in one of the handle halves.

15. The exchangeable blade knife system of claim 14, wherein the bias mechanism comprises a ball and a spring disposed between the ball and the one of the handle halves.

16. The exchangeable blade knife system of claim 11, wherein the bias mechanism comprises a pin having a flange and a compression spring coupled between the pin and the handle, the flange pressing against a tang of the blade when the blade is in the working position.

17. The exchangeable blade knife system of claim 11, wherein the blade comprises a working portion and a tang having a pair of prongs and wherein the bias mechanism presses against the pair of prongs when the blade is in the working position.

18. The exchangeable blade knife system of claim 11, further comprising a second bias mechanism coupled to the handle, the second bias mechanism applying a bias on the blade in the lateral direction to press the blade against the handle when the blade is in the working position.

19. The exchangeable blade knife system of claim 18, further comprising a third bias mechanism coupled to the handle, the third bias mechanism applying a bias on the blade in the lateral direction to press the blade against the handle when the blade is in the working position.

20. The exchangeable blade knife system of claim 11, further comprising a release button configured to secure the blade to the handle and wherein the release button applies a bias on the blade in the lateral direction to press the blade against the handle when the blade is in the working position.

21. A knife, comprising:
a handle;
a blade adapted to be removably coupled to the handle; and
a means for biasing the blade against the handle applying a bias on the blade in a lateral direction to press the blade against the handle;
wherein the blade may be removed from the handle without removing the means for biasing the blade against the handle from the handle.

22. The knife of claim 21, wherein the means for biasing the blade against the handle comprises a compression spring.

23. The knife of claim 21, wherein the handle comprises a receiver and a pair of handle halves coupled to opposite sides of the receiver.

24. The knife of claim 23, wherein the means for biasing the blade against the handle is disposed in a recess in one of the handle halves.

25. The knife of claim 24, wherein the means for biasing the blade against the handle comprises a ball and a spring disposed between the ball and the one of the handle halves.

26. The knife of claim 21, wherein the means for biasing the blade against the handle comprises a pin having a flange and a compression spring coupled between the pin and the handle, the flange pressing against a tang of the blade.

27. The knife of claim 21, wherein the blade comprises a working portion and a tang having a pair of prongs and wherein the means for biasing the blade against the handle presses against the pair of prongs.

28. The knife of claim 21, wherein the means for biasing the blade against the handle comprises a first bias mechanism and a second bias mechanism.

29. The knife of claim 28, wherein the means for biasing the blade against the handle further comprises a third bias mechanism.

30. The knife of claim 21, further comprising a release button configured to couple the blade to the handle and wherein the release button applies a bias on the blade in the lateral direction to press the blade against the handle.
